(19) United States
(12) Patent Application Publication
(10) Pub. No.: US 2022/0194505 A1
(43) Pub. Date: Jun. 23, 2022

(54) SEAT ATTACHABLE TO VEHICLE

(71) Applicant: POLISPORT PLÁSTICOS, SA, Fontanheira, Carregosoa (PT)

(72) Inventor: Pedro Jorge PINTO OLIVEIRA ARAUJO, Vale de Cambra (PT)

(21) Appl. No.: 17/606,482

(22) PCT Filed: Apr. 30, 2020
(86) PCT No.: PCT/IB2020/054070

§ 371 Date: Oct. 26, 2021

(30) Foreign Application Priority Data
Apr. 30, 2019 (PT) 115482

(51) Int. Cl. B62J 1/16

(52) U.S. Cl. CPC B62J 1/16

(57) ABSTRACT

The present application describes a seat that is attachable to a vehicle.

The seat here disclosed comprises a seat, one-piece leg support that tilts over at least one shaft and footrest. The attachable seat comprises at least one shaft that permits joining the seat with the leg support and the respective rotation that permits the tilting of the leg support as a single piece.

Additionally, the seat disclosed in the present patent application further comprises a mechanical fixation system that permits easy attachment and release from the vehicle.

### TECHNICAL FIELD

The present patent application describes a seat that is attachable to a vehicle.

### PRIOR ART

Considering the mobility problems in urban centers, the use of bicycles and other vehicles with small dimensions for transporting people has become a solution increasingly used. In this manner, aspects such as safety of the users of these vehicles are increasingly pressing in society.

Thus, the users are increasingly more aware of the use of safety equipment, such as the equipment now described in this patent application.

Document CN104960602 discloses a chair that is foldable when mounted on the bicycle and differs from the technology herein disclosed since the seat according to the present technology is only foldable prior to being mounted in the vehicle.

Document CN104477286 discloses a foldable/adjustable seat when mounted on the bicycle, specifically on the frame thereof, to work for several sizes of children.

Document WO1997002172A discloses a foldable seat for fixing on a bicycle and differs from the technology herein disclosed since the present technology permits an easy attachment and release from the vehicle as well as permitting easy fixing without separating the seat from the legs.

### SUMMARY

The present patent application describes a seat that is attachable to a vehicle.

The seat that is attachable to a vehicle described in the present patent application comprises:
a seat (1);
a leg support (2) as a single piece which can tilt over at least one shaft (4), wherein the shaft (4) unites the seat (1) and the leg support (2);
a footrest (3), wherein the footrest (3) is fixed to the leg support (2).

In one embodiment, the leg support (2) and the footrest (3) form a single piece that tilts over at least two shafts (4), in connection with the referred seat (1). In one preferred embodiment, the shafts (4) are built from metallic and/or polymeric material.

In another embodiment, the footrest (3) further comprises a footrest tab (10) that permits the fixation and adjustment of the position of the footrest (10) along the vertical groove (15).

In one embodiment, the seat (1) has fitting elements (13) so that the seat (1) and the leg support (2) fit after opening the seat, maintaining the attachable seat stable in its open conformation.

In one embodiment, the seat that is attachable to a vehicle has a mechanical fixation system for attaching to the vehicle. In one preferred embodiment, the fixation system is adapted for fixing to bicycles.

In one embodiment, according to FIGS. 2 to 6, the mechanical fixation system comprises:
a metallic tube (11) in the form of open hoop the closed extremity of which fits in one of the three variable positions (12) under the seat (1), wherein the plate (6) is tightened through a two-action knob handle bolt (7) thus fixing the metallic tube (11) in one of the variable positions (12); the other extremity of the metallic tube (11) is fastened in the vehicle through a clamp (5).

In another embodiment, according to FIGS. 7 to 9, the mechanical fixation system comprises a single piece (14) with a hub (16) that is adjustable through the knob handle bolt (17).

### GENERAL DESCRIPTION

The present application describes a seat, especially developed to be attached to a vehicle, for example a bicycle.

The technology described in the present application arises from the need to increase the ease of usage of the seat and the reduction of the necessary space for its storage and transport.

The seat now disclosed comprises a seat, a single piece leg support that tilts over at least one shaft related to the referred seat, and footrest. The shaft inserted in the seat permits the joining of the seat with the leg support and the respective rotation that permits tilting the leg support as a single piece.

The saddle of the seat is fixed to the vehicle, for example, a bicycle, by means of fixation systems to the bicycle frame (“Frame fixation”—FF), system to attach an infant/child seat to the bicycle frame, under the conductor's seat. It is a system comprised of a metallic tube and a block consisting of plastic and metallic parts. The referred metallic tube is coupled at the bottom of the seat and the other point of the tube is fixed to the block/clamp that is fastened to the bicycle frame. Alternatively, the saddle of the seat may also be fixed by means of support fixation system (“Carrier fixation system”—CFS) used to couple an infant/child seat to the support existing on the rear of the bicycle, over the wheel. This support may come from the factory with the bicycle or be bought as an accessory and subsequently mounted on the bicycle. The CFS system consists in a set of plastic and metallic pieces that fastens the support by means of mechanical tightening action, for example of the screw type.

By “footrest” it is understood two supports for supporting the feet, fixed on each one of the sides of the leg support. The footrest itself, may be uncoupled to the leg support. Additionally, the footrest may be vertically adjusted along a fitting groove, which permits that it be adjusted to the size of the legs of the child being transported.

The saddle of the seat is made from polymeric materials, for example polypropylene, or composites so as to guarantee the lightness of the whole.

As regards the state of the art, the seat here disclosed presents the following advantages:
the leg support that executes the tilting movement is a single piece while other products from the state of the art separate the seat in two parts, namely left leg and right leg, which represents a reduction in the number of mountings and consequently greater safety through the reduction of the probability of bad mountings;
the ease of the tilting movement that permits to easily open and close the leg support without the need of any tool and without taking a long time when the user wishes to assemble and mount the product;
the rotation as defined permits a reduction in space, whether in the transport or in the mounting after use due to the ease in releasing from the vehicle and subsequent rotation. The products disclosed in the state of the art present separate parts with a disassembly process, when possible, more complex and which may take time or damage the product.

### BRIEF DESCRIPTION OF THE FIGURES

For an easy understanding to the present application, figures are attached which represent preferred embodiments which, however, do not intend to limit the technology herein disclosed.

FIG. 1 illustrates one embodiment of the seat that is attachable to vehicles, wherein the seat is in its open position (rotated to be in the normal use position). The referred seat that is attachable to vehicles comprises a seat (1), a leg support (2) and a footrest (3) wherein the seat (1) is united to the leg support (2) by means of at least one shaft (4).

FIG. 2 illustrates a view of the seat attachable to vehicles of the present patent application according to the embodiment which fixation is made through the Frame Fixation system, wherein the numerical references represent:
1—Seat;
2—Leg support;
3—Footrest;
4—Shaft;
11—Metallic tube
15—Vertical grooves for adjusting the footrest.

FIG. 3 illustrates the seat that is attachable to vehicles of the present patent application in its closed conformation, in which scenario the referred seat may be assembled so as to occupy less space.

FIG. 4 illustrates an exploded view of the seat attachable to vehicles of the present patent application according to the embodiment which fixation is made through the Frame Fixation system, wherein the numerical references represent:
1—Seat;
2—Leg support;
3—Footrest;
4—Shaft:
5—Clamp;
6—Metallic plate;
7—Two action knob handle bolt;
8—Screw;
9—Female nut;
10—Footrest tab;
11—Metallic tube.

FIG. 5 illustrates the attachable seat of the present patent application in its open conformation and coupled to a bicycle according to the Frame Fixation system.

FIG. 6 illustrates the lower part of the saddle of the attachable seat of the present patent application, wherein the numerical references represent:
6—Metallic plate
11—Metallic tube
12—Fitting positions of the metallic tube
13—Fixation elements

FIG. 7 illustrates the attachable seat of the present patent application according to the embodiment which fixation is made through the Carrier Fixation System (CFS), wherein the numerical references represent:
1—Seat;
2—Leg support;
3—Footrest;
14—CFS base;
17—Two action knob handle bolt of the CFS base.

FIG. 8 illustrates an exploded view of the seat attachable to vehicles of the present patent application according to the embodiment which fixation is made through the Carrier Fixation System, wherein the numerical references represent:
1—Seat;
2—Leg support;
3—Footrest;
4—Shaft;
10—Footrest tab;
14—CFS base.

FIG. 9 illustrates the base of the CFS system, wherein the numerical references represent:
14—CFS base
16—Adjustable hub
17—Two action knob handle bolt

FIG. 10 illustrates a rear view of the attachable seat of the present patent application, wherein the numerical references represent:
1—Seat;
2—Leg support;
15—Vertical grooves for adjusting the footrest.

### DESCRIPTION OF THE EMBODIMENTS

Referring to the figures, some embodiments are now described in a more detailed manner, which do not intend, however, to limit the scope of the present application.

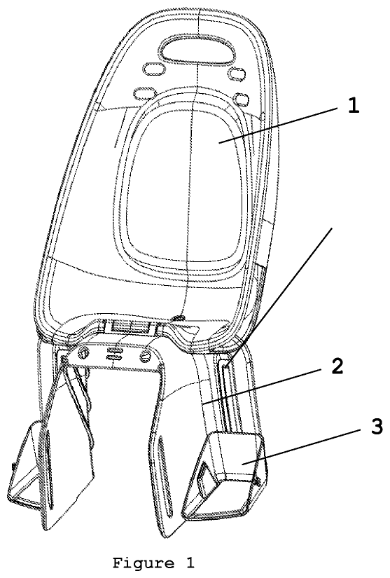

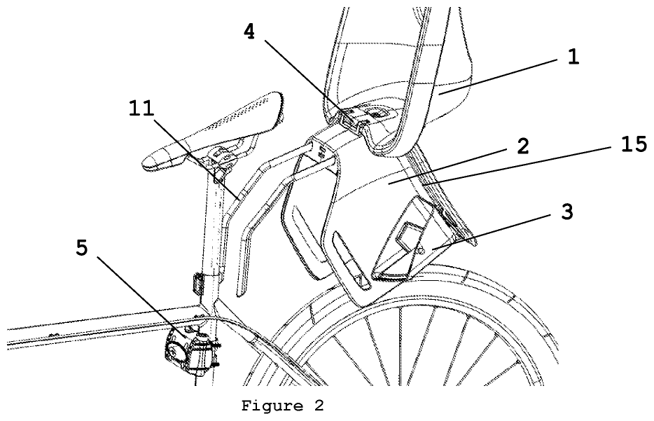

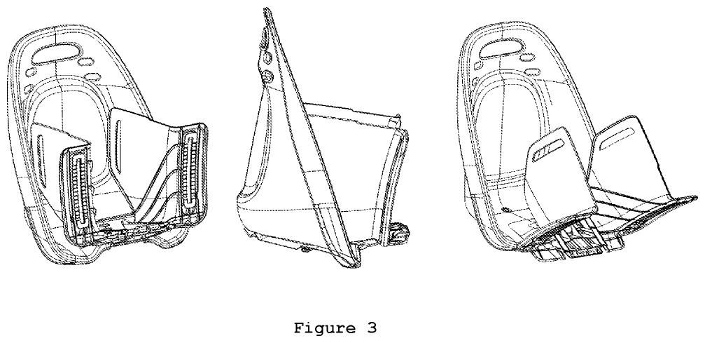

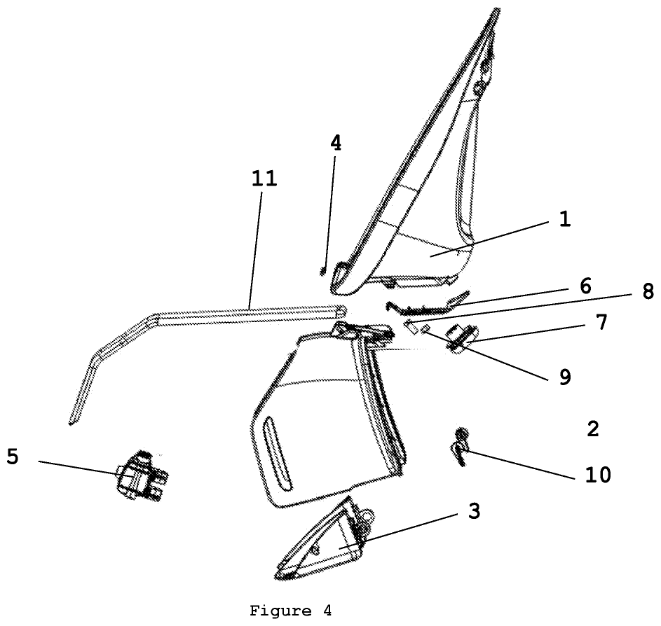

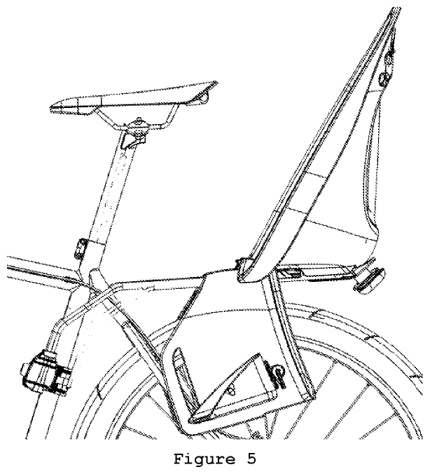

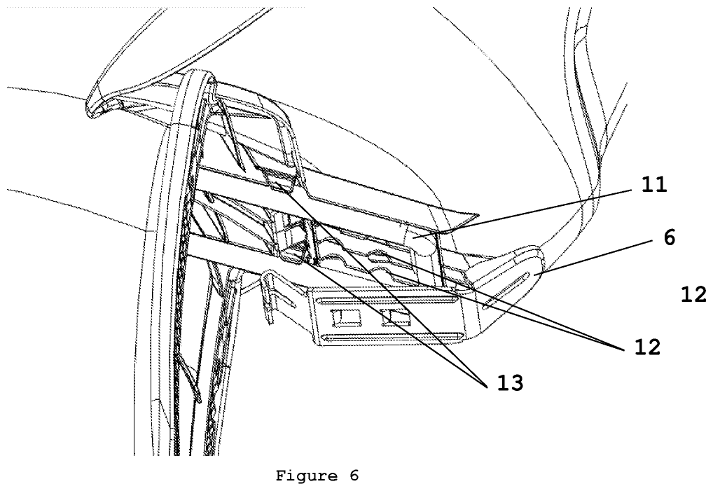

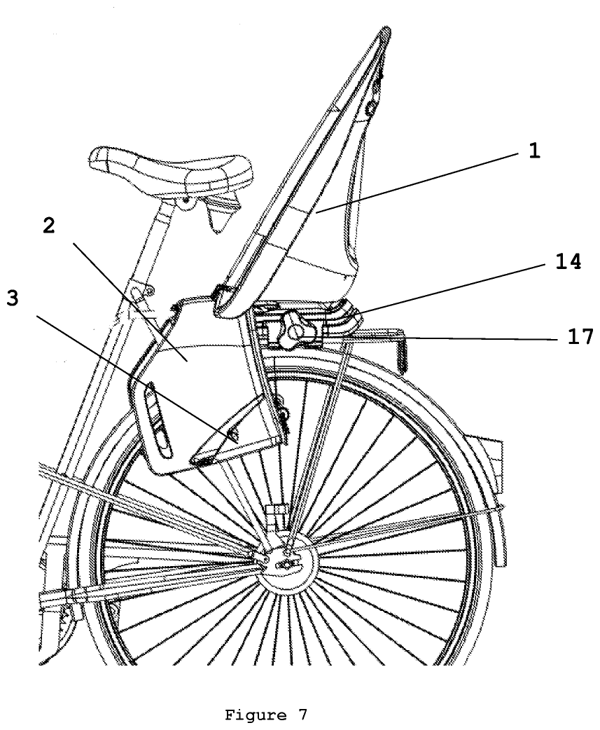

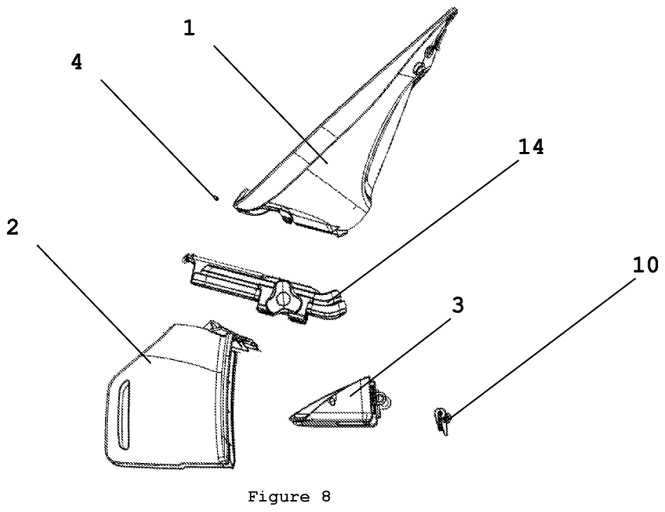

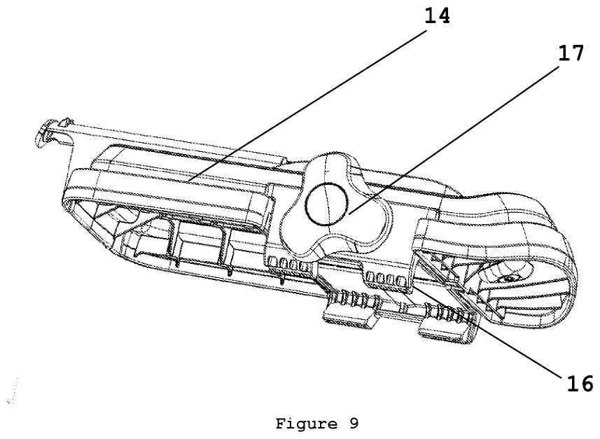

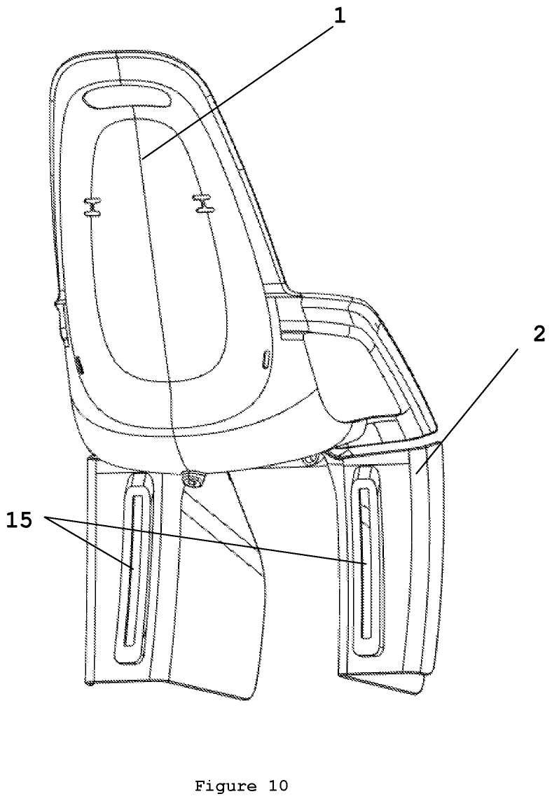

According to FIGS. 1 to 10, the seat attachable to a vehicle comprises:
a seat (1);
a leg support (2) as a single piece that tilts over at least one shaft (4), wherein the shaft (4) unites the seat (1) and the leg support (2);
a footrest (3), wherein the footrest (3) is fixed to the leg support (2).

In one preferred embodiment, the leg support (2) and the footrest (3) form a single piece that tilts over at least two shafts (4), in connection with the referred seat (1). In one preferred embodiment, the shafts (4) are built of metallic and/or polymeric material.

In another embodiment, the footrest (3) further comprises a footrest tab (10) that permits the fixation and adjustment of the position of the footrest (10) along the vertical groove (15).

In one embodiment, the seat (1) has fixation elements (13) in such a manner that the seat (1) and the leg support (2) fit after opening the seat, maintaining the attachable seat stable in its open conformation.

In one embodiment, the seat attachable to a vehicle has a mechanical fixation system for coupling to the vehicle. In one preferred embodiment, the fixation system is adapted for fixing to bicycles.

In one embodiment, according to FIGS. 2 to 6, the mechanical fixation system comprises:

a metallic tube (11) in the shape of an open hoop which closed extremity fits in one of the three variable positions (12) under the seat (1), wherein the plate (6) is tightened through the two action knob handle bolt (7) thus fixing the metallic tube (11) in one of the variable positions (12); the other extremity of the metallic tube (11) is fixed in the vehicle by means of a clamp (5).

In another embodiment, according to FIGS. 7 to 9, the mechanical fixation system comprises a single piece (14) having a hub (16) that is adjustable through the knob handle bolt (17).

The present description is not, naturally, in any way restricted to the embodiments presented in this document and one skilled in the art may foresee many possibilities of altering same without departing from the general idea such as defined in the claims. The preferred embodiments described above are obviously interchangeable. The following claims additionally define preferred embodiments.

1. Seat attachable to vehicles comprising:
a seat;
a leg support as a single piece that tilts over at least one shaft, wherein the shaft unites the seat and the leg support;
a footrest, wherein the footrest is fixed to the leg support.

2. Seat attachable to vehicles according to claim 1, comprising at least two shafts.

3. Seat attachable to vehicles according to claim 1, wherein the leg support comprises a vertical groove along of which the footrest is fixable and adjustable with resource to the footrest tab.

4. Seat attachable to vehicles according to claim 1, wherein the seat has fixation elements in the lower part, in such a manner that the seat and the leg support fit after the seat opening.

5. Seat attachable to vehicles according to claim 1, comprising a mechanical fixation system for coupling to the vehicle.

6. Seat attachable to vehicles according to claim 5, wherein the mechanical fixation system comprises:
a metallic tube in the shape of an open hoop which closed extremity fits in one of the three variable positions under the seat, wherein the plate is tightened through the two action knob handle bolt thus fixing the metallic tube in one of the variable positions; the other extremity of the metallic tube being fixed in the vehicle by means of a clamp.

7. Seat attachable to vehicles according to claim 5, wherein the mechanical fixation system comprises a single piece with a hub adjustable through the knob handle bolt.
